(19) United States
(12) Patent Application Publication
(10) Pub. No.: US 2025/0135766 A1
(43) Pub. Date: May 1, 2025

(54) MULTILAYER EMBOSSMENTS WITH STRAIN-RELIEF FEATURES

(71) Applicant: Pregis LLC, Bannockburn, IL (US)

(72) Inventor: Thomas D. Wetsch, Naples, FL (US)

(21) Appl. No.: 18/935,394

(22) Filed: Nov. 1, 2024

Related U.S. Application Data
(60) Provisional application No. 63/617,285, filed on Jan. 3, 2024.
(60) Provisional application No. 63/616,470, filed on Dec. 29, 2023.
(60) Provisional application No. 63/595,241, filed on Nov. 1, 2023.

(51) Int. Cl. B32B 38/06; B32B 3/30; B32B 7/12; B32B 29/00

(52) U.S. Cl. CPC B32B 38/06; B32B 3/30; B32B 7/12; B32B 29/005; B32B 2250/02; B32B 2255/26; B32B 2307/304; B32B 2307/5825; B32B 2553/00

(57) ABSTRACT

Multi-layer packaging articles can include embossments formed on each layer. The packaging articles can be formed from multi layer webs. An embossing device can locally deform one of the web layers into another, overlying web layer to form the embossments. The webs can include features that permit the web material to be deformed with little, or no tearing of the web material.

### BACKGROUND

Packaging materials are in widespread use to protect small to medium-sized items being shipped in e-commerce and other applications. The packaging materials typically are placed within the shipping box or other container holding the item, and may be used to cushion or thermally insulate the item during shipping.

Many common packaging materials, such as inflatable cushions or pillows, are formed from plastic material such as polyethylene. Paper-based packaging materials are gaining popularity, however, due to the environmentally friendly characteristics of paper such as its recyclability. The use of paper-based packaging materials, however, can present challenges. For example, paper tears more easily than plastic film, which may limit the ability of a paper-based stock material to be formed or otherwise processed into a packaging article having sufficient loft to provide satisfactory cushioning or insulating properties.

### SUMMARY

In one aspect of the disclosed technology, a web for use with an embossing device includes a first substrate layer, and a bonding element disposed on the first substrate layer. The first substrate layer includes a plurality of weakened regions each having one or more cuts formed therein, the one or more cuts being non-symmetrically disposed about a center of the weakened region and configured to facilitate displacement of the weakened regions by a die of the embossing device to form embossments on the first substrate layer.

In another aspect of the disclosed technology, the web includes a second substrate layer overlying the first substrate layer and having a plurality of weakened regions thereon, the weakened regions on the second substrate layer each having one or more cuts formed therein, the one or more cuts being non-symmetrically disposed about a center of the weakened region on the second substrate layer. The bonding element is disposed between the first and second substrate layers and is configured to fix the first substrate layer to the second substrate layer; each of the weakened regions on the second substrate layer overlies an associated weakened region on the first substrate layer; and the weakened regions on the first and second substrate layers are configured to facilitate displacement of the weakened regions as the die forces the weakened regions of the first substrate layer into the associated weakened regions of the second substrate layer to form embossments on the first and second substrate layers.

In another aspect of the disclosed technology, at least one of the first and second substrate layers includes paper.

In another aspect of the disclosed technology, at least one of the first and second substrate layers includes regular kraft paper.

In another aspect of the disclosed technology, at least one of the first and second substrate layers includes extensible paper.

In another aspect of the disclosed technology, the one or more cuts in each of the weakened regions in the first and second substrate layers include a spiral-shaped cut.

In another aspect of the disclosed technology, each of the spiral-shaped cuts in the first substrate curve around a center of the spiral-shaped cut in the first substrate in a first direction and each of the spiral-shaped cuts in the second substrate curve around a center of the spiral-shaped cut in the second substrate in a second direction opposite the first direction.

In another aspect of the disclosed technology, the one or more cuts in each of the weakened regions in the first substrate layer include a spiral-shaped cut and the one or more cuts in each of the weakened regions in the second substrate layer include a plurality of intersecting linear cuts.

In another aspect of the disclosed technology, the first substrate layer and the second substrate layer are formed from a c-folded sheet.

In another aspect of the disclosed technology, the bonding element includes a heat-activatable material. The heat-activatable material can include a heat-sealable material or a hot-melt adhesive. Furthermore, the heat-scalable material can include a polymer dispersion coating or a thermoplastic material.

In another aspect of the disclosed technology, the cuts comprise a line of perforations extending across the weakened area.

In another aspect of the disclosed technology, the web for use with an embossing device forms a packaging article.

In another aspect of the disclosed technology, a system for forming a packaging article includes a supply comprising a first substrate layer, a second substrate layer overlying the first substrate layer, and a bonding element disposed between the first and second substrate layers and configured to fix the first substrate layer to the second substrate layer, at least one of the first and second substrate layers includes a plurality of weakened regions each having one or more cuts formed therein, the cuts being non-symmetrically disposed about a center of the weakened region. The system also includes an embossing device a die configured force the first substrate layer into the second substrate layer at the regions of weakness to form embossments on the first and second substrate layer. The cuts in at least one of the first and second substrate layers are configured to facilitate displacement of the regions of weakness as the die forces the first substrate layer into the second substrate layer at the regions of weakness.

In another aspect of the disclosed technology, the weakened regions are formed in the first and the second substrate layers, the die is configured to force the weakened regions of the first substrate layer into the associated weakened regions of the second substrate layer to formed the embossments and the weakened regions are configured to facilitate displacement of the weakened regions as the die forces the weakened regions of the first substrate layer into the associated weakened regions of the second substrate layer to form the embossments.

In another aspect of the disclosed technology, the cuts are configured to act as strain-relief features that minimize or prevent tearing of the first or second substrate layers as the die forces the first substrate layer into the second substrate layer at the regions of weakness and/or as the embossments are formed.

In another aspect of the disclosed technology, the die is configured to heat the heat-activatable material.

In another aspect of the disclosed technology, the die includes a first roller having a plurality of projections thereon, and a second roller having a plurality of recesses formed therein, the first and second rollers are configured so that each of the projections aligns with and enters a corresponding recess as the first and second rollers rotate in a synchronized manner and the projections are configured to force the first substrate layer into the second substrate layer at the regions of weakness to form the embossments as the first and second substrate layers pass between the first and second rollers.

In another aspect of the disclosed technology, the system include an applicator configured to apply the bonding element to at least one of the first and second substrate layers before the first and second layers reach the die.

In another aspect of the disclosed technology, a packaging article includes a bonding element, a first substrate layer having an embossment thereon and a second substrate layer having an embossment thereon, the embossment on the second substrate layer positioned within the embossment of the first substrate layer and being fixed to the embossment on the first substrate layer by the bonding element. The embossments on at least one of the first and second substrate layers have one or more cuts therein, the cuts being non-symmetrically disposed about a center of the embossment. The one or more cuts of the packaging article can be generally spiral-shaped. Furthermore, the first substrate layer and the second substrate layer can be formed from a c-folded sheet.

In another aspect of the disclosed technology, method for forming a web for use with a forming member, includes providing a supply comprising a first substrate layer, a second substrate layer overlying the first substrate layer, and a bonding element disposed between the first and second substrate layers and configured to fix the first substrate layer to the second substrate layer, at least one of the first and second substrate layers including a plurality of weakened regions each having one or more cuts formed therein, the cuts being non-symmetrically disposed about a center of the weakened region, providing an embossing device configured to receive the first and second substrate layers and comprising a die and using the die, forcing the first substrate layer into the second substrate layer at the regions of weakness to form embossments on the first and second substrate layers.

In another aspect of the disclosed technology, the weakened regions are formed in the first and the second substrate layers and the method further includes forcing the weakened regions of the first substrate layer into the associated weakened regions of the second substrate layer, using the die, to form the embossments.

In another aspect of the disclosed technology, the bonding element includes a heat-activatable material and the method further includes heating the heat-activatable material.

In another aspect of the disclosed technology, method includes heating the heat-activatable material while forcing the first substrate layer into the second substrate layer at the regions of weakness.

In another aspect of the disclosed technology, the method includes heating the heat-activatable material before the heat-activatable material reaches the die.

In another aspect of the disclosed technology, a system for forming a packaging article includes a supply including: a first substrate layer that includes a plurality of weakened regions each having one or more cuts formed therein; and a second substrate layer overlying the first substrate layer and comprising a plurality of detachable stickers each configured to align with a corresponding region of weakness on the first substrate and an embossing device comprising a die configured force the stickers into the corresponding weakened regions on the first substrate form embossments on the first substrate. The cuts in the first substrate layer are configured to facilitate displacement of the regions of weakness as the die forces the stickers into the corresponding weakened regions.

In another aspect of the disclosed technology, a web for use with an embossing device includes a first substrate layer that includes a plurality of weakened regions each having one or more cuts formed therein and a second substrate layer overlying the first substrate layer and comprising a plurality of detachable stickers each configured to align with a corresponding region of weakness on the first substrate.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a perspective view of an embossing system used to produce an embossed packaging article from a web;

FIG. 2 is a bottom perspective view of the packaging article shown in FIG. 1;

FIG. 3 is a top view of the web shown in FIG. 1, in an unassembled state;

FIG. 4 is a side view of an embossing device of the system shown in FIG. 1;

FIG. 5 is a magnified view of a weakened area of the web shown in FIGS. 1 and 3;

FIG. 6 is a magnified view of a weakened area of an alternative embodiment of the web shown in FIGS. 1 and 3;

FIG. 7 is a magnified view of a weakened area of another alternative embodiment of the web shown in FIGS. 1 and 3;

FIG. 8 is a magnified view of a weakened area of another alternative embodiment of the web shown in FIGS. 1 and 3;

FIGS. 9-12 are side views of alternative embodiments of the embossing device shown in FIG. 4; and

FIG. 13 is a perspective view of a web for use with the embossing device of FIG. 12, in an unassembled state.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

Packaging containers can include parcel packaging and other containers to package items. Packaging containers are configured to contain and hold an item, typically enclosing the item, during shipping or storage of the item. Parcel packaging is configured for shipping and/or storing products, such as for storage in warehouse or retail shelves and displays. Examples of parcel packaging include flexible shipping containers such as envelopes, which can have varying degrees of flexibility and typically are used to ship or mail small or relatively flat items or smaller items around which the walls of the envelope can conform. Flexible shipping containers such as envelopes can be padded or non-padded, can be made of materials such as paper and flexible cardboard, can be configured with or without sidewalls or gussets, and can include larger envelopes such as mailers. Examples of parcel packaging also include bags, such as paper or poly bags, which can have a self-sealing capability and are typically used to ship small to medium-sized items; boxes, which can be formed from paperboard, cardboard, wood, or plastic, and typically have a rigid or semi-rigid structure suitable for holding medium to large-size items and heavier items; and shipping tubes or tube mailers, typically used to ship documents and paper items.

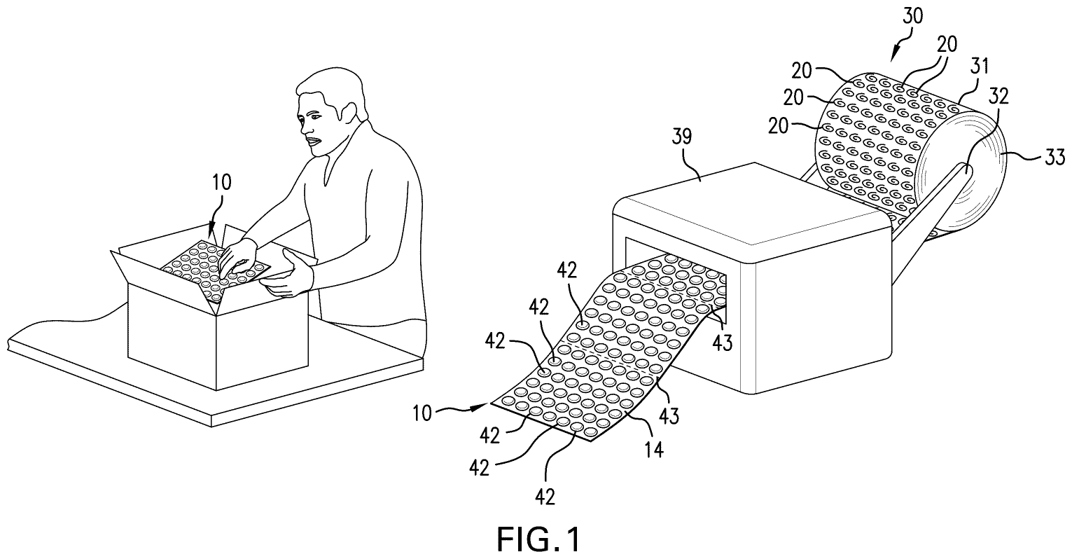

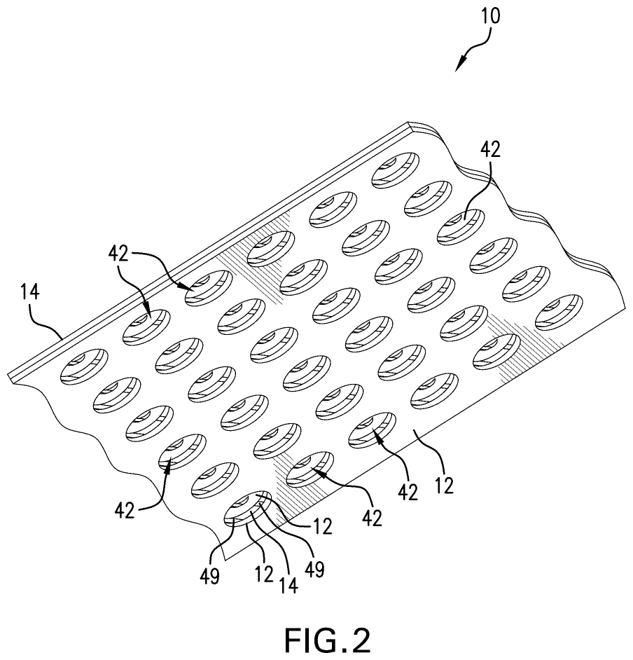

FIGS. 1 and 2 depict a packaging article 10. The packaging article 10 has a plurality of raised areas formed thereon in the form of embossments 42. The packaging article 10 can be placed within a box or other type of shipping container to cushion and protect an article being stored or transported within the shipping container. In some applications, the packaging article 10 can be used to thermally insulate the article being stored or shipped. These applications are presented for illustrative purposes only. The packaging article 10 can be used in other manners in other applications.

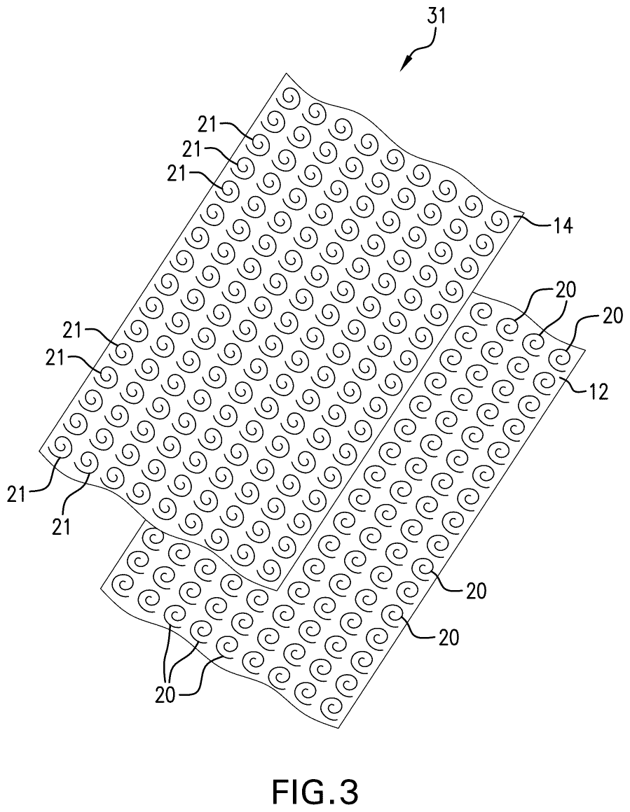

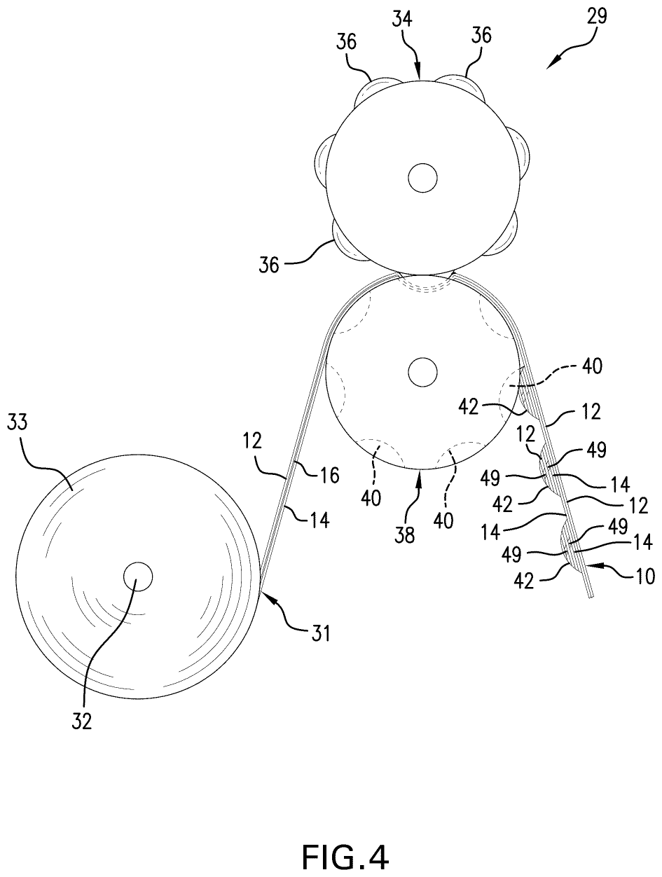

FIG. 3 depicts a web 31 from which the packaging article 10 can be formed, in a pre-assembled state. The web 31 also is visible in FIG. 4. The web 31 comprises a first ply 12, a second ply 14, and a bonding element 16. The first ply 12 is overlayed on the second ply 14, and the bonding element is disposed between the first and second ply 12, 14 as can be seen in FIG. 4. In the fully formed packaging article 10 as depicted in FIGS. 1 and 2, the first ply 12 is fixed to the second ply 14 by the bonding element 16. The packaging article 10 can have a width of, for example, about 15 inches. Alternative embodiments of the packaging article 10 can have a width greater than or less than 15 inches.

The bonding element 16 can be a heat-activatable material, such as a heat-activatable thermoplastic adhesive. For example, the bonding element 16 can be a hot-melt adhesive, a heat-scalable material, or a polymer dispersion. Other types of heat-activatable materials can be used in the alternative.

In other alternative embodiments, the bonding element 16 can be a pressure-sensitive adhesive, a cohesive material, or anther type of bonding element that does not require activation by the application of heat thereto.

In some applications, the bonding element 16 can be activated at the time the web 31 is manufactured. In other applications, the bonding element 16 can be activated some time after the web 31 has been manufactured. The bonding element 16 is configured to remain stable after being applied to the first and/or second plies 12, 14, so that the web 31 can be stored without a need to seal or otherwise isolate the web 31 from the ambient environment. For example, this can permit the web 31 to be manufactured at one location, and then shipped in an unsealed state the end user for conversion into the packaging article 10, as discussed below, at the user's facility. In some applications, the web 31 can be placed in a poly bag or other suitable container immediately or shortly after being manufactured, to help the bonding element 16 remain stable.

Unless otherwise specified herein, the term “stability” should be understood to have its ordinary and customary meaning as recognized by those skilled in the art and can further include the ability to retain one or more properties within a predetermined use duration e.g., within the manufacturer approved lifetime. For example, physical or chemical properties remain substantially constant at room temperature over the predetermined use duration. “Substantially constant,” unless otherwise noted, means within about 10% of a nominal value. Stated another way, the chemical reactivity may be insignificant and/or the tendency to undergo physical changes is minimal over the predetermined use duration.

Stability can be measured according to one or more standards known to a person of skill in the art, e.g., using known ASTM and ISO standards. Stability can also be defined in terms of one or more physical or chemical properties e.g., in the ability to maintain one or more physical or chemical properties over the “use duration” The properties may include, without limitation, capillarity, chemical reactivity e.g., to water, a substrate, solubility, rheological properties, peel strength, hot tack, shear strength and tensile strength, tackiness, viscosity, elasticity, hardness, phase, crystal structure, chemical structure and chemical composition. For example, a peel strength falling within a range of about of 0.2 lb/in to about 10 lb/in and a viscosity falling within a range of about 1,000 cP to about 5,000 cP in a non-dry condition are contemplated.

Stability may also include the ability to maintain one or more properties needed to maintain the ability to form a bond of a pre-determined strength. Bond of a pre-determined strength can be measured according to one or more standards known to a person of skill in the art e.g., ASTM, ISO. For example, standards related to adhesives, or to adhesive properties including, but not limited to, hot tack, shear strength, tensile strength peel strength can be used as a measure of pre-determined bond strength.

Additionally, adhesive stability can be defined in terms of ability to maintain relevant physical and chemical properties, such as those discussed previously, after exposure of the adhesive to certain conditions, e.g., the ambient environment, for a period of time. The ambient environment can be defined as, for example, temperatures ranging between about −25° F. to about 95° F. and relative humidity ranging from about 20 percent to about ninety-five percent.

In the context of a heat-activatable material configured to form a bond between two opposing substrates, “use duration” can refer to the period between manufacture of the material and its activation to form a bond. For example, in the context of the bonding element 16, use duration can include the time period between the bonding element 16 being applied to first and second plies 12, 14 and the bonding element 16 being shipped to an end user and activated (heated). This use duration sometimes is referred to as “shelf life.”

Use duration may be dependent upon environmental conditions and other external factors, and is often specified within a range of one or more environmental conditions such as temperature and humidity.

Referring back to FIG. 3, the bonding element 16 can be configured to retain one or more selected material properties necessary for the heat-activatable material to form a bond, upon being activated, having a strength of a percentage of the pre-determined strength e.g., 70, 75, 80, 85, 90, 95 percent. It should be noted that the bonding element 16 may be configured to retain the one or more selected properties after being applied to plies 12 and/or 14. Furthermore, the bonding element 16 can be configured to form such a bond after being exposed to the ambient environment for a period of time e.g., 12 hours, 48 hours, one month, two years, 5 years, 10 years, or various other use durations. For example, the bonding element 16, may be applied to plies 12 and/or 14 at a first point in time and then activated at a later point in time with the bonding element 16 retaining a peel strength, for example, or other material property above a target threshold, for the duration of time between the application of the bonding element 16 and the application of the bonding element 16. This configuration allows the bonding element 16 to be applied to the plies 12 and/or 14 at a first location and activated at a second location. In some embodiments, the bonding element 16 may be applied to the plies 12, 14 at the first location and then the plies 12, 14 may be embossed and the bonding element activated at the second location.

Bonding elements formed from thermoplastic materials can be advantageous over bonding elements formed from thermosetting materials because thermoplastic materials do not cure upon application of heat, and thus allow the boding element to be heat-activated multiple times e.g., at the time of forming and later at the time of sealing. In addition, thermoplastic materials do not chemically degrade or burn upon re-application of heat.

In some embodiments, the bonding element 16 may include a thermoplastic. In such embodiments, the bonding element 16 can be heated a first time upon being applied to the plies 12 and/or 14, cooled and then heated a second time upon bonding and/or embossing the first and second plies 12, 14.

Hot-melt adhesives are thermoplastic polymers that are solid at room temperature, become molten when heated to an activation temperature above their softening point, and resolidify upon loss of heat at a temperature below a solidifying point, which may be the same as or different than the activation temperature, increasing in strength as they re-solidify. Most hot-melt adhesives, upon melting into a molten state and re-solidifying, do not undergo any chemical reaction such as cross-linking or removal of a carrier, e.g., evaporation of water. Thus, hot-melt adhesives typically can be reactivated, i.e., re-melted and re-solidified, after initially being applied to a substrate.

The hot-melt adhesive, after being applied to the surface to be bonded, can be in a low-tackiness state in which it has a low, or no tackiness in a lower range of temperatures. The hot-melt adhesive is applied hot, and cools and cures in the converting process. The hot-melt adhesive is reactivated by re-heating the hot-melt adhesive up to an activation temperature within a lower range of temperatures. This lower range of application temperatures in some embodiments, for example, is below about 140° F. In other embodiments, for example, the lower range of temperatures is below about 120° F., below about 125° F., or below about 130° F.

The re-heating of the hot-melt adhesive to the activation temperature causes the hot-melt adhesive to become molten. The subsequent cooling of the hot-melt adhesive, in combination with the application of pressure, causes the hot-melt adhesive to bond to the opposing surface, forming a seal between the surfaces.

A heat seal typically is formed by sealing one thermoplastic to the same or a similar thermoplastic. A thermoplastic heat sealable material typically is applied to the two substrates to be fixed to each other. At the time the substrates are to be fixed, the thermoplastic material is subject to heat and pressure sufficient to weld the heat sealable material on the opposing substrates to each other, thereby fixing the substrates together.

In some embodiments, the material for which the bonding element 16 is formed can include one or more polymers, including emulsion-based polymers. The one or more polymers can include one or more of vinyl acetate ethylene, polyvinyl acetate, polyvinyl alcohol, polyvinyl acetate copolymers, polyvinyl alcohol copolymers, dextrin stabilized polyvinyl acetate, vinyl acetate copolymers, ethylene copolymers, vinylacrylic, styrene acrylic, acrylic, styrene butyl rubber, polyurethane, polyolefins, and biodegradable materials (e.g., cellulose and starch). For example, the heat-scalable material can be a polyvinyl alcohol (PVOH) coating a surface of the first ply 12 and/or on a surface of the second ply 14. In some applications, the PVOH can be coated with polyethylene (PE) or polylactic acid (PLA) to prevent the PVOH from sticking, or from absorbing moisture which causes sticking.

In some embodiments, the bonding element 16 can include a polyolefin based dispersion. The polyolefin dispersion can include polyethylene and/or polypropylene, thermoplastic polymers, polymeric stabilizing agents including at least one polar polymer, water, and/or other suitable polyolefin dispersions. A suitable polyolefin dispersion can include, for example HYPOD™, from Dow Chemical, or other suitable polyolefin dispersions.

In some embodiments, the bonding element 16 can be water-based. The water-based bonding element 16 may include a water-based polymer. The use of a water-based bonding element 16 can enhance the recyclability of the packaging articles 10, since the water-based bonding element 16 can be dissolved and separated easily from the paper pulp during the recycling process.

A cohesive material includes a bonding material that causes one surface to stick to an opposing surface by coming into contact with the same or a complimentary cohesive substance to form the bond between the two surfaces. Cohesives do not stick to other substances sufficiently to adhere to those other substances, or in some cases stick very weakly compared to the bond they form from sticking to each other.

The first and second plies 12, 14 can be formed from sheets of paper. The paper can be, for example, regular kraft paper having a basis weight of, for example about 65 grams per square meter to about 122 grams per square meter. The paper can have other basis weights in the alternative. In other alternative embodiments, the paper can be extensible paper.

As used herein, the term “paper” can include, for example, materials composed of cellulose fibers derived from various sources such as wood, cotton, pulp, rags, grasses, vegetable matter or other plant materials, biodegradable materials and recyclable content. It can also include synthetic fibers, or composites. Paper also can include additives, synthetic polymers or specialty coatings to enhance properties like strength, opacity, or water resistance. Paper also can include paper-like materials that mimic traditional paper properties but are made from alternative sources or through novel manufacturing processes.

The first and second plies 12, 14 can include polymers, e.g. polyolefins, polyethylene, polypropylene, polyesters, etc.; paper, e.g., cardboard, kraft paper, fiberboard, pulp-based paper, recycled paper, newsprint, and coated paper such as paper coated with wax, plastic, water-resistant materials, and/or stain-resistant materials; cellulose; foil; poly or synthetic material; biodegradable materials; and/or other suitable materials of suitable thicknesses, weight, and dimensions. The first and second plies 12, 14 also can include recyclable material, e.g., recyclable paper or plastic.

Referring to FIG. 3, the first ply 12 has a plurality of weakened regions 20 formed therein. The second ply 14 likewise has a plurality of weakened regions 21 formed therein. The first and second plies 12, 14 are configured so that each weakened region 20 aligns with a respective weakened region 21 when the first ply 12 is overlayed on the second ply 14. Each of the aligned weakened regions 20, 21 forms a pair 26 of weakened regions.

The weakened regions 20, 21 can be aligned with one another by overlaying first ply 12 over second ply 14. In some embodiments, two sheets of can be overlayed to form the first ply 12 and the underlying second ply 14. In alternative embodiments, a single sheet can be c-folded over a fold line to form the first ply 12 and the underlying second ply 14.

Each of the weakened regions 20, 21 can have at least one cut 24 therein. The cuts 24 help to define the weakened regions 20, 21, and can act as strain-relief features that facilitate displacement of the weakened regions 20, 21 out of the plane of the first or second ply 12, 14 so as to form the embossments 42, with minimal or no tearing of the first and second plies 12, 14. Each cut 24 can extend through the entire thickness of the first and second plies 12, 14. In alternative embodiments, the cuts 24 can be score lines that extend through less than the entire thickness of the first and second plies 12, 14. In other alternative embodiments, the cuts 24 can be perforations. In other alternative embodiments, the cuts 24 can be a thinned region on the first or second plies 12, 14. In other alternative embodiments, the cuts 24 can be point punctures, through-holes, openings, etc.

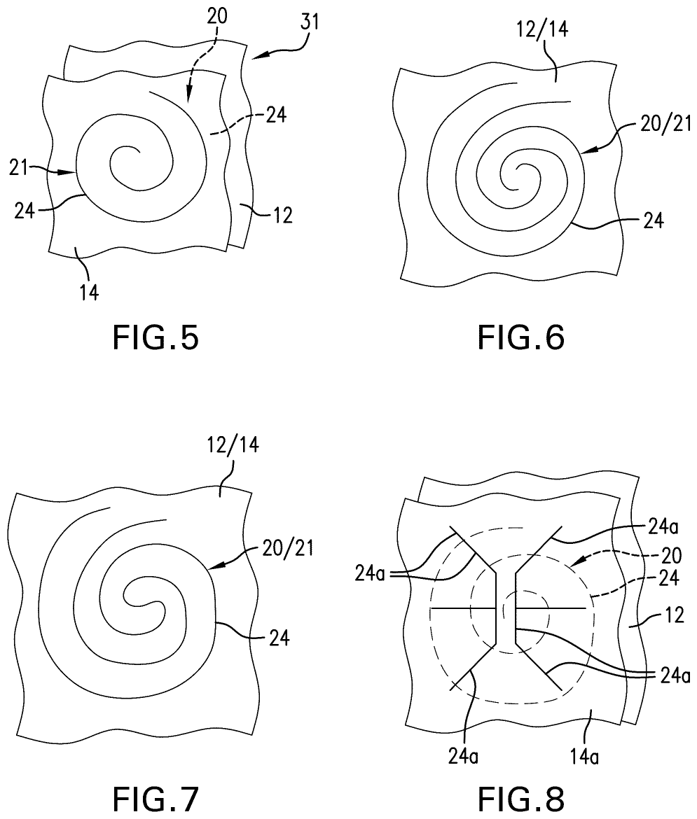

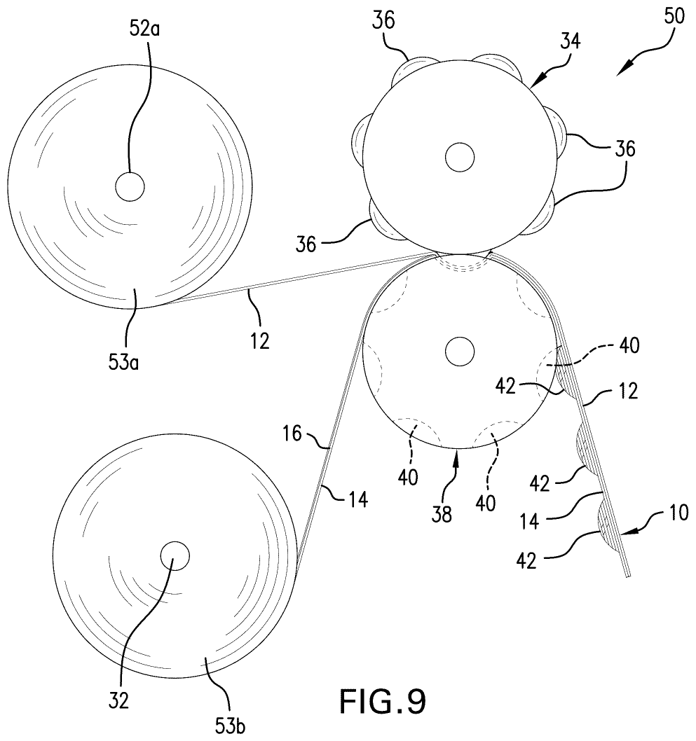

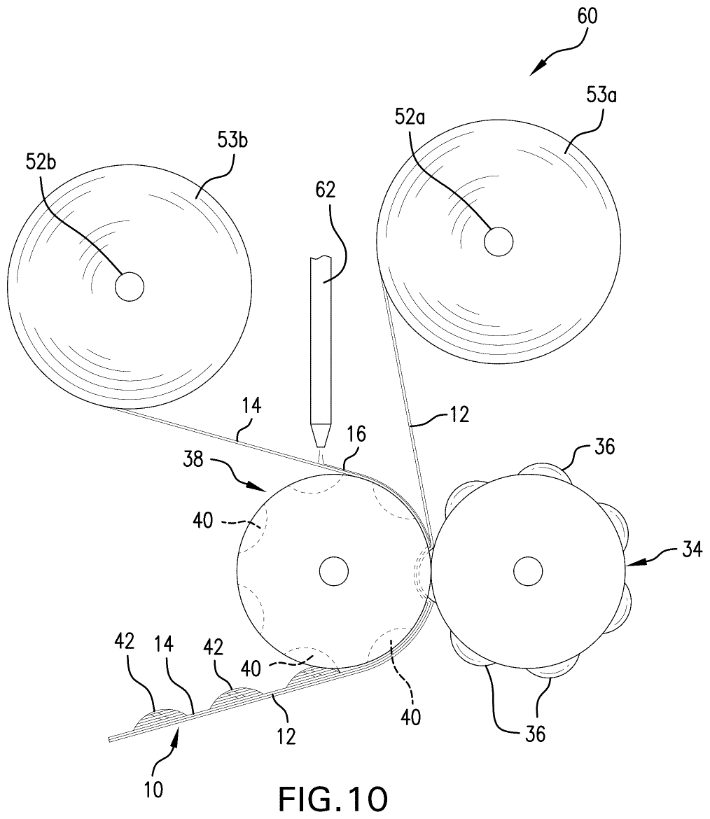

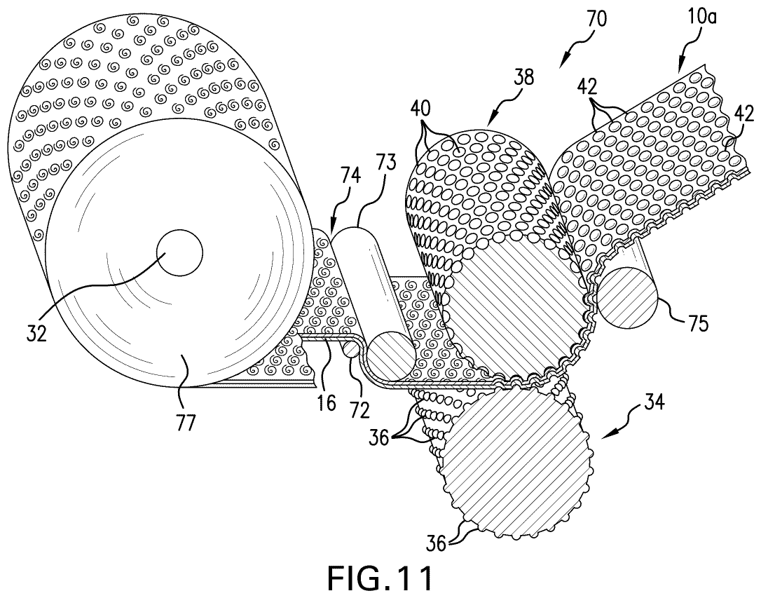

The cuts 24 can have a spiral shape, as shown in FIGS. 5-7. In the embodiment of FIG. 5, one spiral-shaped cut 24 is formed in each weakened region 20, 21. In the embodiment of FIG. 6, two non-intersecting spiral-shaped cuts 24 are formed in each weakened region 20, 21. In the embodiment of FIG. 7, two spiral-shaped cuts 24 that intersect at the inner ends thereof are formed in each weakened region 20, 21. The cuts 24 can have a shape other than spiral in alternative embodiments. For example, FIG. 8 depicts a plurality of linear cuts 24a formed in a second ply 14a. In the embodiment shown in FIG. 8, the plurality of linear cuts 24a may form one or more trapezoidal flaps.

The spiral-shaped cuts 24 in each pair of weakened regions 20, 21 can be angularly offset from each other, as shown in FIG. 5. For example, the spiral-shaped cuts 24 in each pair of weakened regions 20, 21 can extend in opposite directions. In alternative embodiments, the cuts 24 in each pair of weakened regions 20, 21 can extend in the same direction.

In some embodiments, the weakened regions 20, 21 are aligned so that the at least one cut of each weakened region 20, 21 are aligned with one another in a particular manner. For example, the cuts 24 can be reverse mirror images of one another. In embodiments including spiral-shaped cuts 24, for example, weakened region 20 may include a spiral-shaped cut 24 originating from a point of origin and extending from the point of origin in a first direction to form a spiral. Likewise, weakened region 21 can include a spiral-shaped cut 24 originating from a point of origin and extending from the point of origin in a second direction to form a spiral. The first direction may be opposite or substantially opposite the second direction so that corresponding spiral-shaped cuts 24 of corresponding weakened regions 20, 21 are reverse mirror images. In embodiments in which ply 12 and 14 are overlayed on one another via c-folding, the spiral-shaped cuts 24 on a first side of the fold line can extend in the first direction and the spiral-shaped cuts 24 on a second side of the fold line can extend in the second direction.

In alternative embodiments, each of the cuts 24 in the corresponding weakened regions 20, 21 can have the same configuration e.g., spiral-shaped cuts 24 or a plurality of linear cuts 24a, but be offset from one another either linearly or angularly when first ply 12 and second ply 14 are overlayed on one another. In embodiments in which first and second plies 12 and 14 are overlayed on one another via c-folding, the cuts 24 can be distributed asymmetrically on either side of the fold line so that the cuts 24 in corresponding weakened regions 20, 21 are offset from one another upon folding over the fold line.

In alternative embodiments, the cuts 24 of corresponding weakened regions 20, 21 can have different configurations. For example, weakened regions 20 can have cuts configured as the plurality of linear cuts 24a, and the weakened regions 21 can have cuts configured as the spiral-shaped cuts 24 as shown in FIG. 8. In embodiments in which ply 12 and 14 are overlayed on one another via c-folding, the cuts can be distributed either symmetrically or asymmetrically on either side of the fold line.

The cuts 24 in the first ply 12 can act as strain-relief features that permit the weakened regions 20 on the first ply 12 to be displaced out of the initial plane of the first ply 12 with no, or minimal tearing of the adjacent portion of the first ply 12. The cuts 24 in the second ply 14 likewise can act as strain-relief features that permit the weakened regions 21 on the second ply 14 to be displaced out of the initial plane of the second ply 14 with no, or minimal tearing of the adjacent portion of the second ply 14. The initial planes of the first and second plies 12, 14 refer to the respective planes in which the first and second plies 12, 14 lie when in a flat condition, prior to the displacement of the weakened regions 20, 21.

During formation of the packaging article 10, the weakened region 20 of each pair 26 of weakened regions 20, 21 is displaced out of the initial plane of the first ply 12 and toward, and into the corresponding weakened region 21. The weakened regions 20, 21 are displaced together, out of the initial plane of the second ply 14, so that the weakened region 20 nests within the weakened region 21, and the displaced pair 26 of weakened regions 20, 21 forms an embossment 42 on the second ply 14. The first and second plies 12, 14 thus are subjected to an embossing process, with the resulting embossments 42 each including two layers made up of a weakened region 20 of the first ply 12 and the corresponding weakened region 21 of the second ply 14.

FIG. 2 depicts the underside of the fully-formed packaging article 10. As can be seen in FIG. 2, the cuts 24 in the first and second plies 12, 14 have permitted the material from which the first and second plies are formed to expand in the embossed area, resulting in discontinuities within in the embossments 42, including gaps 49 that extend through the first and second plies, 12, 14.

As depicted in FIGS. 1 and 2, all of the embossments 42 extend in the same direction from the initial planes of the first and second plies 12. In alternative embodiments of the packaging article 10, some, e.g., one-half, of the embossments 42 can extend in the direction depicted in FIGS. 1 and 2, and the remaining embossments 42 can extend in the opposite direction. In other alternative embodiments, the embossments 42 can be arranged in rows that extend diagonally across the packaging article.

The bonding element 16 can be heated as the weakened regions 20, 21 are displaced. The heating of the bonding element 16 activates the heat-activatable material which, in combination with the pressure associated with the pressing of the weakened region 20 into the weakened region 21, causes the bonding element 16 to form a bond that fixes the weakened regions 20, 21 (and the first and second plies 12, 14) to each other. The heat can be applied to the bonding element 16 by the roller, die, or other device that is used to displace the weakened regions 20, 21, i.e., the roller or die can be a heated roller or a heated die. Alternatively, or in addition, the heat can be applied by a heating device such a blower, an infrared heater, etc. In some embodiments, the bonding element 16 can be pre-heated before the embossing step.

The temperature to which the bonding element 16 is heated, the pressure applied to the weakened regions 20, 21, and the dwell time, i.e., the time over which the pressure and heat are applied, are application-dependent, and can vary with factors such as the thickness and chemical properties of the bonding element 16, the thickness of the first and second plies 12, 14, the type and properties of the paper or other material from which the first and second plies 12, 14 are formed, etc.

Heat sealing the first and second plies 12, 14 together can increase the stiffness of the packaging article 10. Also, the simultaneous heating and embossing of the weakened regions 20, 21 can enhance the strength and structural integrity of the embossments 42.

FIG. 4 depicts a device 29 for forming the packaging article 10. The device 29 can be part of a system 30 that includes the device 29, the web 31, and a compact individual work cell embosser 39 into which the device is incorporated. The work cell embosser 39 is depicted in FIG. 1. Alternatively, the device 29 can be used in applications in which the device 29 is not incorporated into the work cell embosser 39.

The work cell embosser 39 can be located at the end user's facility, so that the packaging article 10 can be produced from the web 31 on an as-needed basis, i.e., as the packaging article 10 is required by the user. As noted above, the web 31 can be shipped to the end user in a compact configuration, with the embossments 42 not yet formed and with the bonding element 16 in an un-activated state. The web 31 can be configured, for example, in a roll or fan-fold configuration during shipping and storage.

The work cell embosser 39 has a relatively compact configuration that permits the work cell embosser 39 to be placed on a table 8 or other working surface (the table 8 is depicted in FIG. 17). The work cell embosser 39 is configured to receive the web 31, and to form the embossments 42 in the first and second plies 12, 14 while simultaneously heating the bonding element 16 to activate the bonding element 16 and thereby form a bond that fixes the first and second plies 12, 14 to each other. For example, the work cell embosser 39 can be positioned in an area at which shipping containers are loaded prior to being shipped. The packer, i.e., individual worker loading the containers, can activate the work cell embosser 39 using a foot pedal or other suitable device, so that the work cell embosser 39 produces a desired length of packaging article 10 that the packer can cut or otherwise separate from the remainder of the packaging article 10 that has been produced by the work cell embosser 39. In some embodiments, such as shown in FIG. 1, the finished packaging article 10 can have perforations 43 formed therein to permit a length of packaging article 10 to be separated from the remainder of the packing article exiting the work cell embosser 39. Alternatively, a supply of the packaging article 10 can be produced at the end user's facility before the packaging operation, and the supply be drawn upon by the packer as needed.

The packer can wrap the packaging article 10 around as an object being packaged. The packer may wrap the object with multiple layers of the packaging article 10 (as shown in FIG. 17, which depicts an alternative embodiment of the packaging article 10), to help provide maximal protection to the object. Alternatively, or in addition, the packer can line the shipping container with the packaging article 10 as depicted in FIG. 1

The device 29 comprises a die in the form of a first roller 32 and a second roller 34. The web 31, comprising the first and second plies 12, 14 with the weakened regions 20, 21 already formed but not yet displaced out of their original plane; and the bonding element 16 disposed between the first and second plies 12, 14 in an un-activated state. The web 31 is disposed on the first roller 32 as a roll 33 of the web 31. In alternative embodiments, the web 31 can be provided in a fan-folded configuration.

The second roller 34 has a plurality of projections 36 formed thereon. The projections 36 can be dome shaped, so that the embossments 42 formed by the projections 36 likewise are dome shaped. The projections 36 can have other shapes in alternative embodiments, depending on the desired shape of the embossments 42 to be produced by the device 29. For example, the projections 36 of alternative embodiments can be shaped so that the embossments 17 have an oval configuration or a stepped configuration. In other alternative embodiments, the projections 36 can be configured to from a trough or a ridge around each embossment 42.

The device 29 further includes a third roller 38 having a plurality of recesses 40 formed therein. The recesses have a concave profile that matches the convex profile of the projections 36. The second and third rollers 36, 38 rotate in opposite directions, and draw the web 31 from the first roller 32. Each projection 36 is configured to align with a respective recess 40 as the second and third rollers 34, 38 rotate. Also, the web 31 is indexed to the device 29 so that each pair of weakened regions 20, 21 on the web 31 aligns with a projection 36 and its associated recess 40 as the pair of weakened regions 20, 21 passes between the second and third rollers 34, 38.

The projections 36 displace the weakened regions 20 out of the plane of the first ply 12 and into the overlying weakened region 21 on the second ply 14. Also, the projections 36 displace the pair 26 of weakened regions 20, 21 out of the plane of the second ply 14, thereby forming the embossments 42 on the newly formed packaging article 10.

The packaging article 10, once formed, can be cut, torn, or otherwise separated into individual pieces of desired lengths manually or by automated equipment, as shown in FIG. 10.

The embossments 42 can be various sizes. For example, in some embodiments, the base of the embossments 42, i.e., the portion of the embossment 42 has adjoins the adjacent non-embossed surface of the first or second plies 12, 14, can have a maximum dimension of about 1/16-inch up to about one inch. (In the case of the embossments 42, the base has a circular shape; thus, that the maximum dimension of the base is equal to the diameter of the base.) In some embodiments, the maximum dimension of the base can be about 1/16-inch. In other embodiments, the maximum dimension of the base can be about ¾-inch. In other embodiments, the maximum dimension of the base can be about ½-inch. These size ranges are presented for illustrative purposes only. The maximum dimension of the base can have other values in alternative embodiments.

As can be seen FIG. 4, the height of the embossments 42, i.e., the elevation of the peak of the embossment 42 in relation to the base of the embossment 42, is less than the diameter of the base. The height of the embossments 42 can be about equal to, or greater than the diameter of the base in alternative embodiments.

One or both of the second and third rollers 34, 38 can be heated, so that the contact between the pair of weakened regions 20, 21 and the second and/or third rollers 34, 38 results in heating and activation of the bonding material between the first and second plies 12, 14. In alternative embodiments of the device 29, the heating can be performed by a separate heater.

In alternative embodiments of the device 29, the die can be configured as a stamping die, a blower, or another type of mechanism in lieu of the second and third rollers 34, 38.

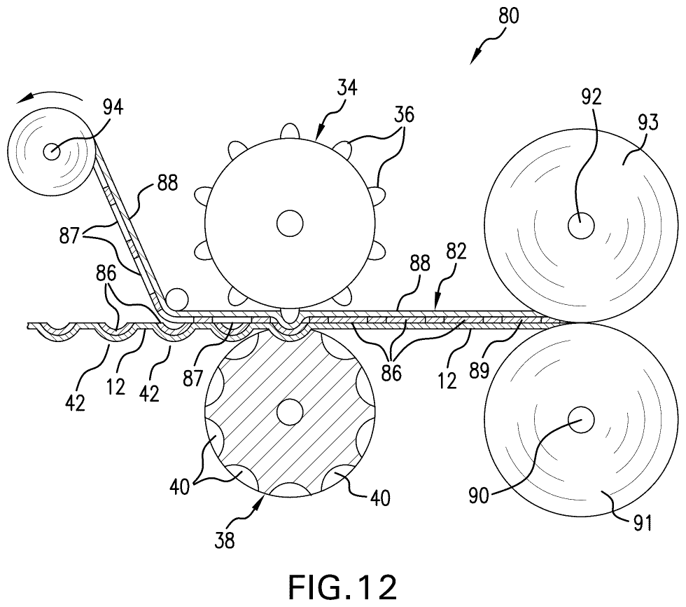

FIG. 9 depicts an alternative embodiment of the device 29 in the form of a device 50. The device 50 includes the second and third rollers 34, 38 of the system 30. The device 50 includes rollers 52a, 52b. The roller 52a has the first ply 12 disposed thereon in a rolled configuration. The roller 52b has the second ply 14 disposed thereon in a rolled configuration. The first and second plies 12, 14 are disposed on the rollers 52a, 52b as respective rolls 53a, 53b. The first and second plies 12, 14 are drawn between the second and third rollers 34, 38 separately, and become overlayed upon passing between the second and third rollers 34, 38. The bonding element 16, as described above in relation to the web 31, can be disposed on the inwardly-facing surfaces of the first ply 12 and/or the second ply 14, i.e., the first and/or second plies 12, 14 can be provided on the respective rollers 52a, 52b with the bonding element 16 disposed thereon. (FIG. 9 depicts the bonding element 16 as being applied to the second ply 14 only.) The first and second plies 12, 14, upon passing between the second and third rollers 34, 38, become embossed as discussed above in relation to the web 31.

In alternative embodiments of the device 50, the bonding element 16 can be a pressure-sensitive adhesive applied to the first ply 12. The adhesive can be covered by a release strip while the first ply 12 is on the roller 52a. The device can be configured to automatically remove the release strip as the first ply 12 travels between the roller 52a and the second and third rollers 34, 38.

FIG. 10 depicts another alternative embodiment of the device 29 in the form of a device 60. The device 60 is substantially identical to the device 50, with the exception that the device 60 includes an applicator 62 that applies the bonding element 16 to the second ply 14 after the second ply 14 has been unwound from the roller 52a, and before the second ply 14 reaches the second and third rollers 34, 38. In this embodiment, the first and second plies are provided on the respective rollers 52a, 52b without the bonding element 16 applied thereto. In alternative embodiments of the device 60, the bonding element 16 can be applied to the first ply 12 in addition to, or instead of the second ply 14.

FIG. 11 depicts another alternative embodiment of the device 29 in the form of a system 70. The system 70 is substantially identical to the system 30, with the following exception. The system 70 includes two additional rollers 72, 73 that pre-heat opposite sides of a web 74 before the web 74 reaches the second and third rollers 34, 38. The web 37 is disposed on the first roller 32 as a roll 77 of the web 74. In other alternative embodiments, only one of the rollers 72, 73 can be a heated roller. Also, the device 70 can include an additional roller 75 that helps to guide the newly-formed packaging article 10a as it comes out of contact with the roller 38. Also, the pairs 26 of weakened regions 20 are offset so that the embossments 42 formed on the packaging article 10a are arranged in staggered rows.

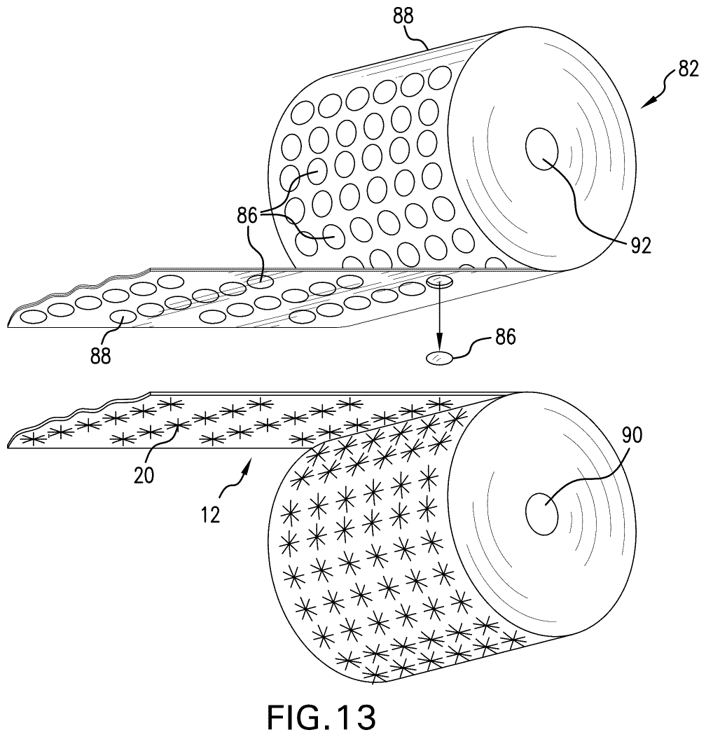

FIG. 12 depicts another alternative embodiment of the device 29 in the form of a device 80. The device 80 is configured for use with a web 82, shown in FIG. 13. The web 82 includes the first ply 12, a layer 89, and a release layer 88. The layer 89 is disposed on the release layer 88, and includes a plurality of stickers 86. The first ply 12 is provided in a rolled configuration and is disposed on a first roller 90 of the device 80. The release layer 88 and the stickers 86 are provided in a rolled configuration and are disposed a second roller 92 of the device 80. The first ply and the web 82 are disposed on the rollers first and second rollers 90, 92 respective rolls 91, 93.

The release layer 88 and the layer 89 (including the stickers 86) are aligned with and overlayed on the first ply 12 as the release layer 88 and stickers 86 and the first ply 12 are drawn from the respective second and first rolls 92, 90, so that each sticker 86 aligns with a respective weakened region 20 on the first ply 12. The resulting web 82 is indexed to the second and third rollers 34, 38 so that each of the aligned pairs of stickers 86 and weakened regions 20 aligns with a corresponding projection 36 and recess 44 on the respective second and third rollers 34, 38. The projection 36 displaces the corresponding weakened region 20 and the adjacent sticker 86, to form an embossment 42. The release layer 88, without the stickers 86, subsequently is rolled onto a roller 94 located downstream of the second and third rollers 34, 38. The spaces within the layer 89 resulting from the removal of the stickers 86 are denoted in FIG. 12 by the reference character 87. In alternative embodiments, the web 82 can be configured with disks having a heat-activatable bonding element thereon, in place of the stickers 86.

In alternative embodiments of the web 31, the weakened regions 20, 21 can be formed on only one of the first and second plies 12, 14, with the other ply being formed without any cuts. For example, FIG. 14 depicts an alternative embodiment of the web 31 in the form of a web 120, in an unassembled state. The web 120 comprises the second ply 14, and a ply 122 having no weakened regions thereon. (The web 120 is depicted without the bonding element 16, for clarity of illustration.) Alternatively, the web 120 can include the first ply 12 and the ply 122. Forming the cuts in only one of the plies obviates the need to index the first ply 12 and the ply 122 to each other when forming the web 120, or when feeding the first ply 12 and the ply 122 individually to rollers or other dies as in the devices 50, 60.

In other alternative embodiments, the cuts can be distributed extensively across one or both of the plies, and can be spaced closely enough so that each pair of projections and recesses on the rollers or other forming device will align with at least one cut on the plies during the forming operation. In some embodiments, the cuts can be substantially smaller than the projections or other devices used to emboss the plies. For example, FIG. 15 depicts an alternative embodiment of the web 31 in the form of a web 126, in an unassembled state. The web 126 comprises the first ply 12, and a ply 128 in which cuts 130 are distributed extensively throughout the ply. Alternatively, the web 126 can include the second ply 14 and the ply 128. (The web 120 is depicted without the bonding element 16, for clarity of illustration.) In this particular, embodiment, the cuts 130 are randomly-oriented and in some cases intersect other cuts 130. In other embodiments, the cuts 130 may be distributed in a non-random manner. The extensive distribution of the cuts 130 obviates the need to index the first ply 13 and the ply 128 to each other when forming the web 126, or when feeding the first ply 12 and the ply 128 individually to rollers or other forming devices as in the devices 50, 60, in order to provide the strain-relief provided by the cuts.

In some embodiments, for example, the cuts 130 can be formed across at least about ten percent of the surface of the ply 128. In other embodiments, for example, the cuts 130 can be formed across at least about 25 percent of the surface of the ply 128. In other embodiments, for example, the cuts 130 can be formed across at least about 50 percent of the surface of the ply 128.

FIG. 16 depicts another alternative embodiment in the form of a web 132, in an unassembled state. The web comprises the ply 128, and another ply 134 substantially similar to the ply 128 in which the cuts 130 are distributed extensively across the ply 132. (The web 120 is depicted without the bonding element 16, for clarity of illustration.) Thus, there is no need to index the plies 128, 134 to each other when forming the web 132, or when feeding the plies 128, 134 individually to rollers or other forming devices as in the devices 50, 60. Also, because the cuts 130 are distributed extensively throughout both plies 128, 134, there is no need to index the web 132, or the individual plies 128, 134, to the forming device.

In other alternative embodiments, both of the plies can be formed without any cuts. In such embodiments, tearing of the plies as the embossments are formed can be avoided or minimized by minimizing the size of the embossments. For example, FIGS. 17-19 depict an alternative embodiment in the form of a packaging article 100 having embossments 102 formed thereon. The packaging article 100 comprises a first ply 104, and a second ply 106 fixed to the first ply 104 by a heat-activatable bonding element 16 as discussed above in relation to the packaging article 10. FIG. 17 depicts a piece of the packaging article 100 being wrapped multiple times around an object 104 being packaged in a box 105, to provide protection to the object 104 during shipping.

The packaging article 100 can be formed from a pre-formed web 107 as discussed above in relation to the packaging article 10. The web 107 is depicted in cross-section FIG. 19, and as a roll 111 of the web 107 in FIG. 17. Alternatively, the packaging article 100 can be formed by feeding the first and second plies 104, 106 on an individual basis to rollers or other forming devices as in the devices 50, 60.

The embossments 102 have a spherical shape. The embossments 102 can have other shapes in alternative embodiments.

The embossments 102 can have a diameter (measured at the base thereof) of, for example, about ¾-inch or less. The diameter of the embossments 102 is denoted by the arrow 108 in FIGS. 18 and 19. (Because the embossments are spherical, the diameter of the base also represents the maximum and minimum dimension of the base.) In other embodiments, the embossments 102 can have a diameter of, for example, about ½-inch or less. In other embodiments, the embossments 102 can have a diameter of, for example, about ¼ inch or less. In other embodiments, the embossments 102 can have a diameter of, for example, about 1/16-inch to about ¼-inch.

In some embodiments, the height of the embossments 102 can be no greater than about ½ the diameter of the embossments 102 (as measured at the base of the embossments 102). In other embodiments, the height of the embossments 102 can be no greater than about ⅓ the diameter of the embossments 102. In other embodiments, the height of the embossments 102 can be no greater than about ¼ the diameter of the embossments 102. For example, in some embodiments, the base can have a diameter of about 0.35 to about 0.60 inch, and the height of the embossment 102 can be about 0.12 inch to about 0.20 inch. In other embodiments, for example, the base can have a diameter of about 0.475 inch, and the height of the embossment 102 can be about 0.158 inch.

Embosser protrusion height, corresponding to “inside depth” of paper dome—. 148″ (3.8 mm). Embosser protrusion diameter, corresponding to “ID” of paper dome—. 440″ (11.2 mm).

The embossments 102 can be spaced by, for example, about 1/32-inch to about ⅛-inch. The spacing between the embossments 102 is denoted by the arrow 110 in FIG. 18. The embossments 102 can be spaced by less than 1/32-inch, or more than ⅛-inch in alternative embodiments. The density with which the embossments 102 are disposed on the packaging article 100 can be, for example, about nine embossments 102 per square inch to about 120 embossments 102 per square inch. The density with which the embossments 102 are disposed on the packaging article 100 can be greater than, or less than these values in alternative embodiments.

The localized displacement of the plies 104, 106 caused by the projections 36 on the roller 34 (or other forming device) may cause the material of each of the first and second plies 104, 106 to stretch, and to gather toward of the areas on the first and second plies 104, 106 being displaced by the projections 36. The collective gathering of the material at the various locations of the projections 36 may cause the material to slide over the projections 36. The ability of the first and second plies 104, 106 to stretch, and to slide over the projections 36 can reduce the tendency of the first and second plies 104, 106 to tear as the embossments 102 are formed. For example, the ability of the first and second plies 104, 106 to stretch and slide without tearing can be affected by factors such as the thickness, stretchability, and water content of the paper or other material from which the first and second plies 104, 106 are formed; the height of the projections 36 (and the embossments 102); the spacing between the embossments 102, etc.

The relatively small size of the embossments 102 may discourage or prevent the plies first and second 104, 106 from tearing as the first and second plies 104, 106 undergo localized displacement during formation of the embossments 102. Also, if any such tearing does occur, the relatively small size of the embossments 102 may limit such tearing to acceptable levels, i.e., to levels that do not significantly affect the cushioning, insulating, or other relevant properties of the packaging article 100. For example, limiting the height of the embossments to one-half of the maximum dimension of the base gives the embossments 102 a relative shallow configuration that can help to minimize or eliminate tearing of the plies 104, 106 as the embossments 102 are formed. (In embodiments having non-spherical embossments in which the dimensions of the base may vary along the length or width of the base, limiting the ratio of the local height of the embossment to the corresponding local minimum dimension of the base of the embossment can help to minimize or eliminate tearing of the as the embossments are formed.)

The ability to eliminate or limit tearing of the first and second plies 104, 106 without a need to place cuts or other cuts in the areas to be embossed makes it unnecessary to index the first and second plies 102, 104 to each other when forming the first and second plies 102, 104 into a web, or when feeding the first and second plies 104, 106 individually to rollers or other forming devices as in the devices 50, 60. Also, the absence of cuts in the first and second plies 104, 106 obviates the need to index the web, or the individual first and second plies 104, 106, to the forming device.

In all of the above embodiments, additional plies can be added so that the resulting packing article includes more than two substrate layers.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A web for use with an embossing device, the web comprising:
a first substrate layer, and a bonding element disposed on the first substrate layer, wherein:
the first substrate layer includes a plurality of weakened regions each having one or more cuts formed therein, the one or more cuts being non-symmetrically disposed about a center of the weakened region and configured to facilitate displacement of the weakened regions by a die of the embossing device to form embossments on the first substrate layer.

2. The web of claim 1, further comprising a second substrate layer overlying the first substrate layer and having a plurality of weakened regions thereon, the weakened regions on the second substrate layer each having one or more cuts formed therein, the one or more cuts being non-symmetrically disposed about a center of the weakened region on the second substrate layer, wherein:
the bonding element is disposed between the first and second substrate layers and is configured to fix the first substrate layer to the second substrate layer;
each of the weakened regions on the second substrate layer overlies an associated weakened region on the first substrate layer; and
the weakened regions on the first and second substrate layers are configured to facilitate displacement of the weakened regions as the die forces the weakened regions of the first substrate layer into the associated weakened regions of the second substrate layer to form embossments on the first and second substrate layers.

3. The web of claim 1, wherein at least one of the first and second substrate layers comprises paper.

4. The web of claim 3, wherein at least one of the first and second substrate layers comprises extensible paper.

5. The web of claim 2, wherein the one or more cuts in each of the weakened regions in the first and second substrate layers include a spiral-shaped cut.

6. The web of claim 5, wherein:
each of the spiral-shaped cuts in the first substrate curve around a center of the spiral-shaped cut in the first substrate in a first direction; and
each of the spiral-shaped cuts in the second substrate curve around a center of the spiral-shaped cut in the second substrate in a second direction opposite the first direction.

7. The web of claim 2, wherein:
the one or more cuts in each of the weakened regions in the first substrate layer include a spiral-shaped cut; and
the one or more cuts in each of the weakened regions in the second substrate layer include a plurality of intersecting linear cuts.

8. The web of claim 1, further comprising a c-folded sheet comprising the first substrate layer and the second substrate layer.

9. The web of claim 1, wherein the bonding element comprises a heat-activatable material.

10. The web of claim 1, wherein the bonding element comprises a thermoplastic material.

11. The web of claim 1, wherein the cuts are configured to act as strain-relief features that minimize or prevent tearing of the first or second substrate layers as the embossments are formed.

12. The web of claim 1, wherein the cuts comprise a line of perforations extending across the weakened area.

13. A system for forming a packaging article, comprising:
a supply comprising a first substrate layer, a second substrate layer overlying the first substrate layer, and a bonding element disposed between the first and second substrate layers and configured to fix the first substrate layer to the second substrate layer, at least one of the first and second substrate layers includes a plurality of weakened regions each having one or more cuts formed therein, the cuts being non-symmetrically disposed about a center of the weakened region; and
an embossing device comprising a die configured force the first substrate layer into the second substrate layer at the regions of weakness to form embossments on the first and second substrate layers, wherein:
the cuts in at least one of the first and second substrate layers are configured to facilitate displacement of the regions of weakness as the die forces the first substrate layer into the second substrate layer at the regions of weakness.

14. The system of claim 13, wherein:
the weakened regions are formed in the first and the second substrate layers;
the die is configured to force the weakened regions of the first substrate layer into the associated weakened regions of the second substrate layer to formed the embossments; and
the weakened regions are configured to facilitate displacement of the weakened regions as the die forces the weakened regions of the first substrate layer into the associated weakened regions of the second substrate layer to form the embossments.

15. The system of claim 13, wherein the cuts are configured to act as strain-relief features that minimize or prevent tearing of the first or second substrate layers as the die forces the first substrate layer into the second substrate layer at the regions of weakness.

16. The system of claim 13, wherein the cuts comprise a line of perforations extending across the weakened area.

17. The system of claim 13, wherein at least one of the first and second substrate layers comprises paper.

18. The system of claim 17, wherein at least one of the first and second substrate layers comprises extensible paper.

19. The system of claim 13, wherein the bonding element comprises a heat-activatable material.

20. The system of claim 19, wherein the die is configured to heat the heat-activatable material.

21. The system of claim 13, wherein:
the die comprises a first roller having a plurality of projections thereon, and a second roller having a plurality of recesses formed therein;
the first and second rollers are configured so that each of the projections aligns with and enters a corresponding recess as the first and second rollers rotate in a synchronized manner;
the projections are configured to force the first substrate layer into the second substrate layer at the regions of weakness to form the embossments as the first and second substrate layers pass between the first and second rollers.

22. The system of claim 13, further comprising an applicator configured to apply the bonding element to at least one of the first and second substrate layers before the first and second layers reach the die.

23. The system of claim 13, wherein the one or more cuts in each of the weakened regions in the first and second substrate layers include a spiral-shaped cut.

24. The system of claim 23, wherein:
each of the spiral-shaped cuts in the first substrate wind around a center of the spiral-shaped cut in the first substrate in a first direction; and
each of the spiral-shaped cuts in the second substrate wind around a center of the spiral-shaped cut in the second substrate in a second direction opposite the first direction.

25. The web of claim 13, wherein:
the one or more cuts in each of the weakened regions in the first substrate layer include a spiral-shaped cut; and
the one or more cuts in each of the weakened regions in the second substrate layer include a plurality of intersecting linear cuts.

26. A packaging article formed for the web of claim 1.

27. A packaging article unit, comprising:
a bonding element;
a first substrate layer having an embossment thereon; and
a second substrate layer having an embossment thereon, the embossment on the second substrate layer positioned within the embossment of the first substrate layer and being fixed to the embossment on the first substrate layer by the bonding element, wherein:
the embossments on at least one of the first and second substrate layers have one or more cuts therein, the cuts being non-symmetrically disposed about a center of the embossment.

28. The packaging unit of claim 27, wherein at least one of the first and second substrate layers comprises paper.

29. The packaging unit of claim 28, wherein at least one of the first and second substrate layers comprises extensible paper.

30. The packaging unit of claim 27, wherein the one or more cuts are generally spiral-shaped.

31. The packaging unit of claim 27, further comprising a c-folded sheet comprising the first substrate layer and the second substrate layer.

32. A method for forming a web for use with a forming member, the method comprising:
providing a supply comprising a first substrate layer, a second substrate layer overlying the first substrate layer, and a bonding element disposed between the first and second substrate layers and configured to fix the first substrate layer to the second substrate layer, at least one of the first and second substrate layers including a plurality of weakened regions each having one or more cuts formed therein, the cuts being non-symmetrically disposed about a center of the weakened region;
providing an embossing device configured to receive the first and second substrate layers and comprising a die; and
using the die, forcing the first substrate layer into the second substrate layer at the regions of weakness to form embossments on the first and second substrate layers.

33. The method of claim 32, wherein:
the weakened regions are formed in the first and the second substrate layers; and
the method further comprises forcing the weakened regions of the first substrate layer into the associated weakened regions of the second substrate layer, using the die, to form the embossments.
